(19) United States
(12) Patent Application Publication
(10) Pub. No.: US 2025/0053663 A1
(43) Pub. Date: Feb. 13, 2025

(54) HIGH-EFFICIENCY VULNERABILITY SCANNING

(71) Applicant: International Business Machines Corporation, Armonk, NY (US)

(72) Inventors: Tiberiu Suto, Franklin, NY (US); Heather Nicole Polgrean, Lagrangeville, NY (US); Zachary A. Silverstein, Georgetown, TX (US); Logan Bailey, Atlanta, GA (US)

(21) Appl. No.: 18/448,315

(22) Filed: Aug. 11, 2023

(51) Int. Cl. G06F 21/57; G06F 9/455

(52) U.S. Cl. CPC G06F 21/577; G06F 9/45558; G06F 2009/45587

(57) ABSTRACT

A method including generating a queue of a plurality of workloads for execution in a data processing environment, where the plurality of workloads are organized in the queue based on respective priority values, and where a vulnerability scan is queued with a lower priority value and segmenting the vulnerability scan using at least one selected from a group consisting of: parallel segmentation and iterative segmentation. The parallel segmentation is configured to implement respective segments of the vulnerability scan at predetermined times to reduce downtime or performance impact of the data processing environment and the iterative segmentation is configured to repeatedly segment the vulnerability scan until respective segments of the vulnerability scan can be implemented in the data processing environment without any downtime or significant performance impact. The method further includes implementing the segmented vulnerability scan in the data processing environment.

### BACKGROUND

The present invention relates generally to vulnerability scanning, and more specifically, to high efficiency vulnerability scanning to improve security and throughput.

Data breaches of any kind are devastating and costly occurrences that can have wide spread impact on events around the world as well as within a company. IBM Security recently announced the results of a global study which found that data breaches now cost surveyed companies $4.24 million per incident. The average cost of a data breach increased 2.6% from USD 4.24 million in 2021 to USD 4.35 million in 2022, and this number is expected to continue to rise in the coming years. Additionally, cloud-based services were at fault for 45% of the data breaches that occurred during the 12-month period leading up to March 2022 and across the 550 organizations IBM studied. To prevent data breaches, companies implement frequent vulnerability scanning for their systems.

### SUMMARY

In accordance with an embodiment, a method is provided. The method includes generating a queue of a plurality of workloads for execution in a data processing environment, where the plurality of workloads are organized in the queue based on respective priority values, and where a vulnerability scan is queued with a lower priority value and segmenting the vulnerability scan using at least one selected from a group consisting of: parallel segmentation and iterative segmentation. The parallel segmentation is configured to implement respective segments of the vulnerability scan at predetermined times to reduce downtime or performance impact to the data processing environment and the iterative segmentation is configured to repeatedly segment the vulnerability scan until respective segments of the vulnerability scan can be implemented in the data processing environment without any downtime or significant performance impact. The method further includes implementing the segmented vulnerability scan in the data processing environment.

In accordance with another embodiment, a computer program product is provided, the computer program product comprising a computer readable storage medium having program instructions embodied therewith. The program instructions are executable by a computer to cause the computer to generate a queue of a plurality of workloads for execution in a data processing environment, where the plurality of workloads are organized in the queue based on respective priority values, and where a vulnerability scan is queued with a lower priority value and segment the vulnerability scan using at least one selected from a group consisting of: parallel segmentation and iterative segmentation. The parallel segmentation is configured to implement respective segments of the vulnerability scan at predetermined times to reduce downtime or performance impact of the data processing environment and the iterative segmentation is configured to repeatedly segment the vulnerability scan until respective segments of the vulnerability scan can be implemented in the data processing environment without any downtime or significant performance impact. The program instructions are executable by a computer to cause the computer to implement the segmented vulnerability scan in the data processing environment.

In accordance with yet another embodiment, a system is provided. The system includes a memory and one or more processors in communication with the memory configured to cause the computer to generate a queue of a plurality of workloads for execution in a data processing environment, where the plurality of workloads are organized in the queue based on respective priority values, and where a vulnerability scan is queued with a lower priority value and segment the vulnerability scan using at least one selected from a group consisting of: parallel segmentation and iterative segmentation. The parallel segmentation is configured to implement respective segments of the vulnerability scan at predetermined times to reduce downtime or performance impact of the data processing environment and the iterative segmentation is configured to repeatedly segment the vulnerability scan until respective segments of the vulnerability scan can be implemented in the data processing environment without any downtime or significant performance impact. The system further implements the segmented vulnerability scan in the data processing environment.

It should be noted that the exemplary embodiments are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be described within this document.

These and other features and advantages will become apparent from the following detailed description of illustrative embodiments thereof, which is to be read in connection with the accompanying drawings.

### BRIEF DESCRIPTION OF THE DRAWINGS

The invention will provide details in the following description of preferred embodiments with reference to the following figures wherein:

FIG. 1 is a block/flow diagram of an exemplary system for high efficiency vulnerability scanning to improve security and throughput, in accordance with an embodiment of the present invention;

FIG. 2 is a block/flow diagram of an exemplary method for high efficiency vulnerability scanning to improve security and throughput, in accordance with an embodiment of the present invention;

FIG. 3 is a block/flow diagram of an exemplary method for implementing a segmented vulnerability scan in a data processing environment, in accordance with an embodiment of the present invention; and

FIG. 4 is a block diagram of an exemplary computer system for implementing high efficiency vulnerability scanning to improve security and throughput, in accordance with an embodiment of the present invention.

Throughout the drawings, same or similar reference numerals represent the same or similar elements.

### DETAILED DESCRIPTION

Embodiments in accordance with the present invention provide methods and systems for high efficiency vulnerability scanning to improve security and throughput. Vulnerability scanning is an inspection of the potential points of exploit on a computer or network to identify security holes. A vulnerability scan detects and classifies system weaknesses in computers, networks and communications equipment, and predicts the effectiveness of countermeasures. However, vulnerability scanning is currently limited in its performance capacity by several factors. The constraints are that vulnerability scans can be system impacting, they can take time to complete, and can bog down a job queue if done during high volume hours. For these reasons it is often challenging for security administrators to know when to schedule vulnerability scans. If a high priority job comes in, vulnerability scans may have to be halted mid-session and not continued, or they may be delayed which can present a risk for the company.

The exemplary embodiments of the present invention address all of these challenges and create a secure, cost-efficient security system that can balance the performance impact while cognitively addressing the security risk in a way not possible with traditional methods.

It is to be understood that the present invention will be described in terms of a given illustrative architecture; however, other architectures, structures, substrate materials and process features and steps/blocks can be varied within the scope of the present invention. It should be noted that certain features cannot be shown in all figures for the sake of clarity. This is not intended to be interpreted as a limitation of any particular embodiment, or illustration, or scope of the claims.

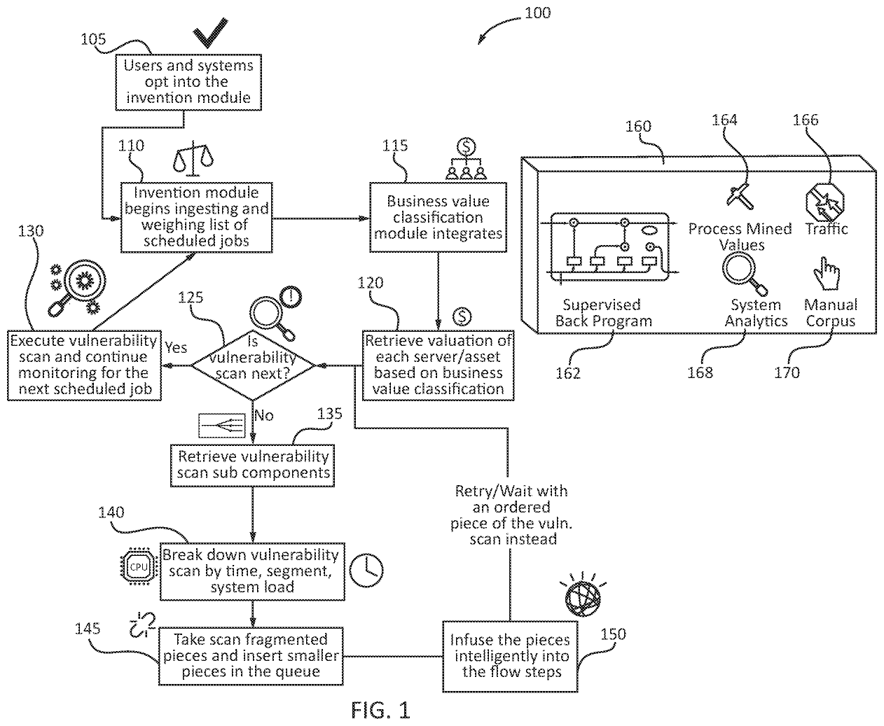

FIG. 1 is a block/flow diagram of an exemplary system for high efficiency vulnerability scanning to improve security and throughput, in accordance with an embodiment of the present invention.

The high efficiency vulnerability scanning system 100 includes users and systems that opt into the exemplary system at block 105.

At block 110, the exemplary system begins ingesting and weighting a list of scheduled jobs.

At block 115, the business value classification module (or classifier) is integrated.

At block 120, the valuation of each server or asset is retrieved based on business value classification.

At block 125, it is determined whether a vulnerability scan is next.

If YES, the process proceeds to block 130. At block 130, the system executes vulnerability scans and continues monitoring for the next scheduled job. If NO, the process proceeds to block 135.

At block 135, the system retrieves vulnerability scan sub-components.

At block 140, the system breaks down vulnerability scan by time, segment, and system load.

At block 145, the system takes scanned fragmented pieces and inserts smaller pieces into a queue.

At block 150, the system infuses the pieces intelligently into the flow steps.

At block 160, a supervised back program 162 is employed, which includes process mined values 164, traffic 166, system analytics 168, and manual corpus 170.

The high efficiency vulnerability scanning system 100 can be implemented as follows:

Generate a list of systems that are part of the vulnerability scanning scope.

Servers are weighted along the lines of individual business value which can then be given preference accordingly. These parameters of business value can be programmed along the lines of sales, global impact to clients for server outages, or impact to employees and internal processes in order to determine areas of greatest priority. (Example: Server A has a business value of $100/min for it to be operational between 9 AM and 5 PM)

Weighting is done with a supervised back propagation neural network that can then be left to learn over time after initial conditioning. Predictions are given to the system to analyze and the system takes and uses these estimates to improve future predictions.

Jobs related to high priority servers or tags can then be assigned a weighted value automatically and these values are used to determine priority in the queue. A security scan is always queued but will have a low priority to accommodate these necessary jobs and not bog down the servers.

In some embodiments, the exemplary system takes the vulnerability scan and fractures it into smaller parts. The smaller pieces may be fractured based on time, segmentation, or functionality. These smaller parts are fractured and executed in parallel with the system. When they are fractured, the exemplary system can utilized in a bi-modal manner.

Regarding parallel fractured scanning, the exemplary system identifies what type of resource consumption the smaller fractured piece will use, what systems it impacts, and pick the most optimal parallel time to execute it. This time balances impact with security. Parallel segmentation is configured to implement respective segments of the vulnerability scan at predetermined times to reduce downtime or performance impact of the data processing environment.

Regarding iterative fractured scanning, the exemplary system simply breaks down a larger vulnerability scan into smaller pieces and tries and fits them in wherever instead of trying to fit a full vulnerability scan in. Iterative segmentation is configured to repeatedly segment the vulnerability scan until respective segments of the vulnerability scan can be implemented in the data processing environment without any downtime or significant performance impact.

If a security scan is running and a high priority job is submitted, the exemplary system pauses the security scan and saves the progress by either marking the port or the IP address that it was probing at the time of the pause so it knows where it can continue.

In addition to performing routine scans that investigate ports and IP addresses sequentially, the exemplary system can also perform randomized security scans that are conducted out of order for the purposes of probing the systems in a way the developers might not intend which can potentially identify unexpected security issues.

Each server contains an agent that can provide information regarding the jobs currently running on that server and scheduled to run at later times.

Servers can be assigned different tags based on the types of operations they complete and how they relate to other servers, meaning, that servers all related to sales within a specific business sector would be linked together via that tag. This would enable the security scanners to evaluate the impact of running a scan on a set of servers and how this might impact the bottom line. What the impacts of running a scan are versus the benefits would enable more intelligent scheduling of scans in the future without the intervention of a security expert.

The exemplary system will be able to run N number of scans in parallel. The exemplary system would take N systems of the highest priority as established above and then start the scans. When a system is encountered where the impact of the scan would outweigh the benefits of such, the system would temporarily skip the scan on that system and add it to the queue to be completed later.

In some embodiments, in types of scenarios where there is no ideal time to run the scan because of 24×7 system usage, the system restores a most recent snapshot for a backup on a separate virtual machine (VM) and performs scans against the VM so as not to impact the production box. Vulnerability remediations can then also be tested against this virtual box to ensure they can apply without any impact to the running workload before being applied to the production machine. To determine when to apply this process, the exemplary method will calculate the cost of impact to the production environment to run the scan versus the cost of generating a VM from a snapshot. In cases where the former exceeds the latter, this process will be implemented.

The exemplary system further links common vulnerabilities and exposures (CVE) reports into determining sequence of scan ports and narrow the ports scanned to the most likely ones to be vulnerable based on those. This can allow much faster application of vulnerability remediations by detecting the highest likelihood of vulnerability across a larger set of systems.

In one practical application, a person, who is the chief information security officer (CISO) of a large organization is always looking for ways to improve his/her enterprise security posture and better protect the systems and applications from potential cyberattacks. With the current vulnerability scanning systems, the enterprise has been limited in terms of scheduling scans during off-hours, which may not be sufficient to detect and address all potential vulnerabilities.

However, with the exemplary system described herein, the enterprise can now assign weighted values to incoming jobs, thus allowing for a more efficient and automated process that isn't limited to specific times. The partitioned methodology of collection ensures that if a high-priority job is submitted, the system can pause a security scan without losing progress, which helps maintain an uninterrupted workflow.

Furthermore, the parallel scanning feature enables initiation of different scans on separate systems, thus improving efficiency and agility. Overall, the exemplary system has the potential to significantly improve security operations, reduce the risk of targeted breaches, and increase the efficiency of security scanning processes.

In another practical application, in a managed security service provider (MSSP) environment, an organization provides security services to multiple clients. In this practical case, the MSSP may be responsible for managing security scans for different clients, which can be challenging to manage efficiently with the current vulnerability scanning systems.

With the exemplary system described herein, the MSSP can assign weighted values to incoming jobs, enabling them to prioritize security scans based on client needs and criticality. This ensures that the most important scans are conducted promptly, and clients receive timely and effective security services.

Additionally, the partitioned methodology of collection enables the MSSP to pause and resume scans efficiently, without interrupting other ongoing tasks. This allows them to provide uninterrupted service to clients and maintain the integrity of their work queue.

Moreover, the parallel scanning feature allows the MSSP to initiate different scans on separate systems simultaneously or concurrently, further improving efficiency and agility in managing security operations.

Overall, the exemplary system can significantly enhance the ability of MSSPs to provide efficient and effective security services to multiple clients while maintaining high levels of security and minimizing the risk of targeted breaches.

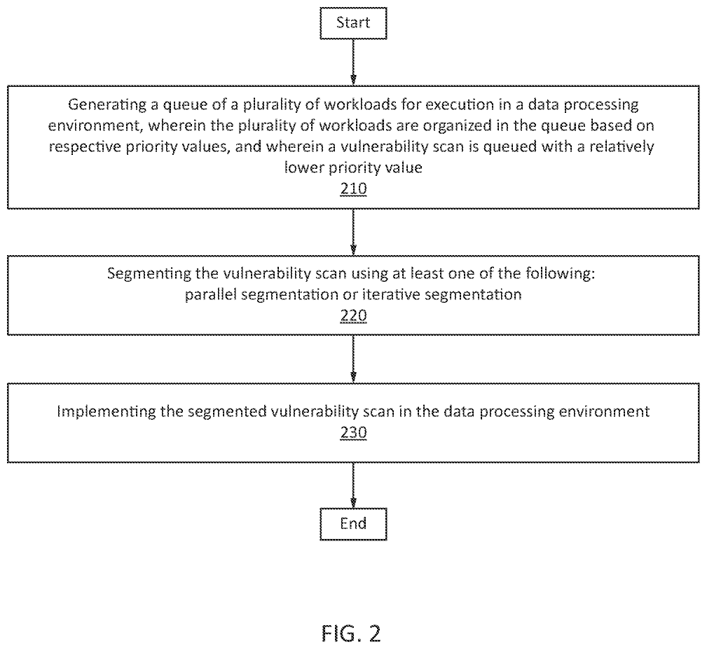

FIG. 2 is a block/flow diagram of an exemplary method for high efficiency vulnerability scanning to improve security and throughput, in accordance with an embodiment of the present invention.

At block 210, generate a queue of a plurality of workloads for execution in a data processing environment, wherein the plurality of workloads are organized in the queue based on respective priority values, and wherein a vulnerability scan is queued with a relatively lower priority value.

At block 220, segment the vulnerability scan using at least one the following: parallel segmentation or iterative segmentation.

At block 230, implement the segmented vulnerability scan in the data processing environment.

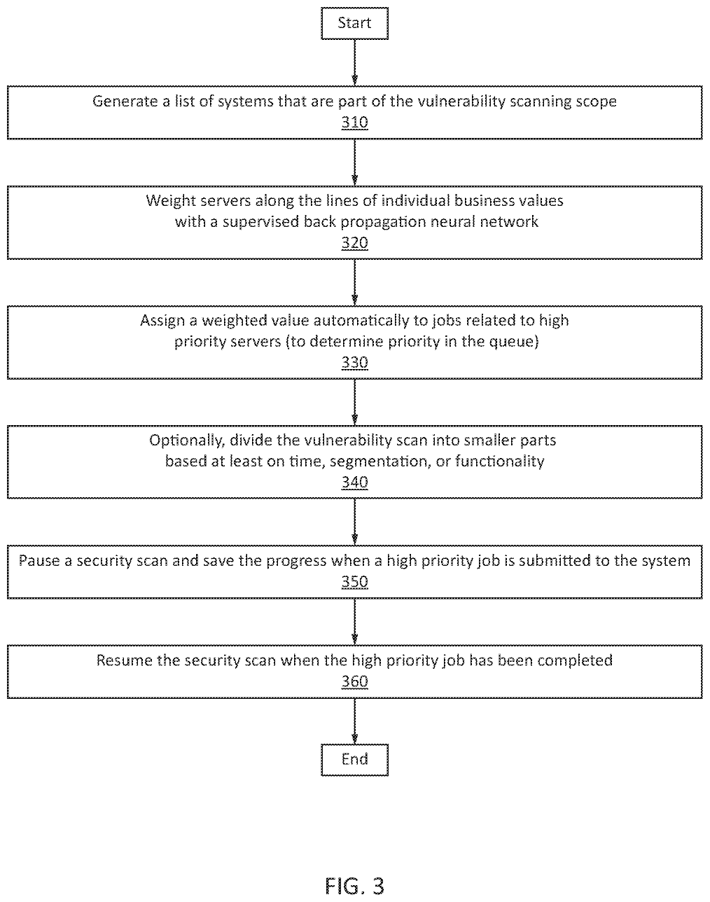

FIG. 3 is a block/flow diagram of an exemplary method for implementing a segmented vulnerability scan in a data processing environment, in accordance with an embodiment of the present invention.

At block 310, generate a list of systems that are part of the vulnerability scanning scope.

At block 320, weigh servers along the lines of individual business values with a supervised backpropagation neural network

At block 330, assign a weighted value automatically to jobs related to high priority servers (to determine priority in the queue).

At block 340, optionally, divide the vulnerability scan into smaller parts based at least on time, segmentation, or functionality.

At block 350, pause a security scan and save the progress when a high priority job is submitted to the system.

At block 360, resume the security scan when the high priority job has been completed.

In conclusion, a system and method is presented to weigh jobs in relation to a vulnerability scan or fractured pieces of a vulnerability scan to optimize machine performance and security. The exemplary system assigns weighted values to incoming jobs and queues a vulnerability scan with a lower value so that security scanning becomes a dynamic process. The security scan is able to dynamically fragment and work around other system workloads, so that it is not relegated to the “off hours,” which improves security and can lower the risk of targeted breaches. The exemplary system implements a partitioned methodology of collection. For example, if a security scan is taking place and a highly weighted job is submitted, the security scan can be paused without losing the current progress and can be picked up again, and then the job is completed. The exemplary system further enables parallel scanning, thus allowing separate system scans to work in parallel based on network and system resource requirements and existing workloads. This drastically improves security and efficiency because a different scan can be started on a separate system until the first machine becomes available again, the work queue isn't interrupted, the network remains agile and security scans become unpredictable to outside malicious forces. The exemplary system further dynamically fragments scans based on running and scheduled workload capabilities extracted from interfacing with process mining or process orchestration systems.

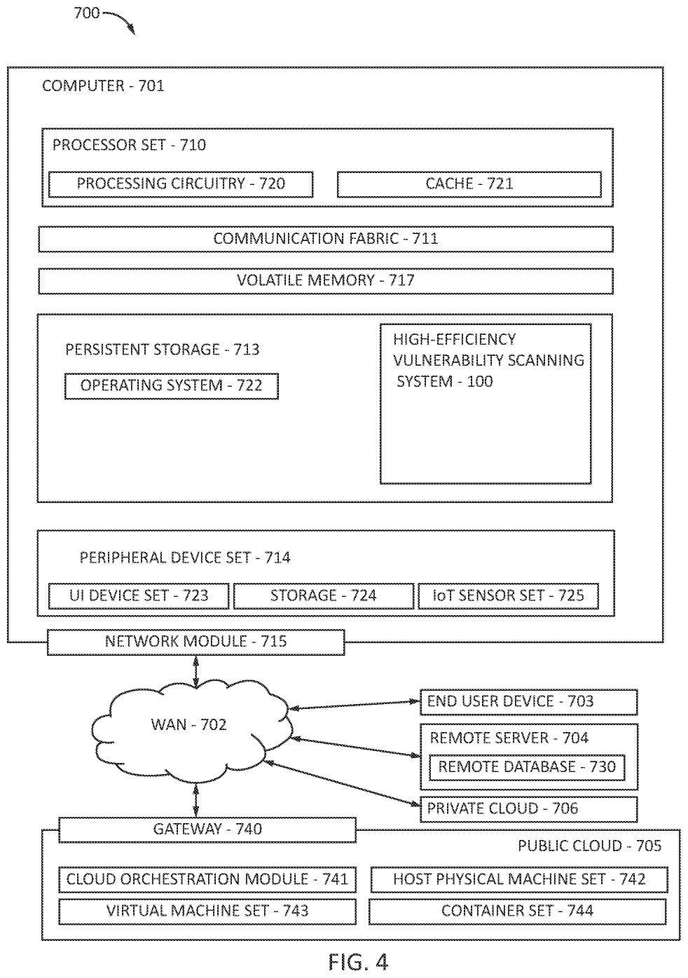

FIG. 4 is a block diagram of an exemplary computer system for implementing high efficiency vulnerability scanning to improve security and throughput, in accordance with an embodiment of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is usually moved at some occasional points in time during normal operations of a storage device, such as during access, de-fragmentation or garbage collection, but this does not render the storage device as transitory because the data is not transitory while it is stored.

Computing environment 700 contains an example of an environment for the execution of at least some of the computer code involved in performing the inventive methods, such as the audio and high efficiency vulnerability scanning system 100. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 6. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It is also noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments for high efficiency vulnerability scanning to improve security and throughput (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A method comprising:
generating a queue of a plurality of workloads for execution in a data processing environment, wherein the plurality of workloads are organized in the queue based on respective priority values, and wherein a vulnerability scan is queued with a lower priority value;
segmenting the vulnerability scan using at least one selected from a group consisting of: parallel segmentation and iterative segmentation;
wherein the parallel segmentation is configured to implement respective segments of the vulnerability scan at predetermined times to reduce downtime or performance impact of the data processing environment; and
wherein the iterative segmentation is configured to repeatedly segment the vulnerability scan until respective segments of the vulnerability scan can be implemented in the data processing environment without any downtime or performance impact; and
implementing the segmented vulnerability scan in the data processing environment.

2. The method of claim 1, further comprising:
in response to a receiving a high priority job while implementing the segmented vulnerability scan, pausing the segmented vulnerability scan and resuming the segmented vulnerability scan in response to completion of the high priority job.

3. The method of claim 1, further comprising:
in response to a server of the data processing environment having no foreseeable downtime to run the segmented vulnerability scan, generating a virtual machine (VM) using a snapshot of the server and implementing the vulnerability scan on the VM.

4. The method of claim 1, further comprising assigning weighted values to incoming jobs so that a security scan becomes a dynamic process.

5. The method of claim 4, wherein the security scan dynamically fragments and works around other system workloads so that it is not relegated to off hours.

6. The method of claim 1, wherein parallel scanning is enabled to allow separate system scans to work in parallel based on network and system resource requirements and existing workloads.

7. The method of claim 1, further comprising dynamically fragmenting scans based on running and scheduled workload capabilities extracted from interfacing with process mining or process orchestration systems.

8. A computer program comprising a computer readable storage medium having program instructions embodied therewith, the program instructions executable by a computer to cause the computer to:
generate a queue of a plurality of workloads for execution in a data processing environment, wherein the plurality of workloads are organized in the queue based on respective priority values, and wherein a vulnerability scan is queued with a lower priority value;
segment the vulnerability scan using at least one selected from a group consisting of: parallel segmentation and iterative segmentation;
wherein the parallel segmentation is configured to implement respective segments of the vulnerability scan at predetermined times to reduce downtime or performance impact of the data processing environment; and
wherein the iterative segmentation is configured to repeatedly segment the vulnerability scan until respective segments of the vulnerability scan can be implemented in the data processing environment without any downtime or performance impact; and
implement the segmented vulnerability scan in the data processing environment.

9. The computer program product of claim 8, wherein, in response to a receiving a high priority job while implementing the segmented vulnerability scan, pause the segmented vulnerability scan and resuming the segmented vulnerability scan in response to completion of the high priority job.

10. The computer program product of claim 8, wherein, in response to a server of the data processing environment having no foreseeable downtime to run the segmented vulnerability scan, generate a virtual machine (VM) using a snapshot of the server and implementing the vulnerability scan on the VM.

11. The computer program product of claim 8, further comprising assigning weighted values to incoming jobs so that a security scan becomes a dynamic process.

12. The computer program product of claim 11, wherein the security scan dynamically fragments and works around other system workloads so that it is not relegated to off hours.

13. The computer program product of claim 8, wherein parallel scanning is enabled to allow separate system scans to work in parallel based on network and system resource requirements and existing workloads.

14. The computer program product of claim 8, further comprising dynamically fragmenting scans based on running and scheduled workload capabilities extracted from interfacing with process mining or process orchestration systems.

15. A system comprising:
a memory; and
one or more processors in communication with the memory configured to:
generate a queue of a plurality of workloads for execution in a data processing environment, wherein the plurality of workloads are organized in the queue based on respective priority values, and wherein a vulnerability scan is queued with a lower priority value;
segment the vulnerability scan using at least one selected from a group consisting of: parallel segmentation and iterative segmentation;
wherein the parallel segmentation is configured to implement respective segments of the vulnerability scan at predetermined times to reduce downtime or performance impact of the data processing environment; and
wherein the iterative segmentation is configured to repeatedly segment the vulnerability scan until respective segments of the vulnerability scan can be implemented in the data processing environment without any downtime or performance impact; and
implement the segmented vulnerability scan in the data processing environment.

16. The system of claim 15, wherein, in response to a receiving a high priority job while implementing the segmented vulnerability scan, paus the segmented vulnerability scan and resuming the segmented vulnerability scan in response to completion of the high priority job.

17. The system of claim 15, wherein, in response to a server of the data processing environment having no foreseeable downtime to run the segmented vulnerability scan, generate a virtual machine (VM) using a snapshot of the server and implementing the vulnerability scan on the VM.

18. The system of claim 15, further comprising assigning weighted values to incoming jobs so that a security scan becomes a dynamic process.

19. The system of claim 18, wherein the security scan dynamically fragments and works around other system workloads so that it is not relegated to off hours.

20. The system of claim 15, wherein parallel scanning is enabled to allow separate system scans to work in parallel based on network and system resource requirements and existing workloads.
